(19) United States
(12) Patent Application Publication
(10) Pub. No.: US 2009/0130891 A1
(43) Pub. Date: May 21, 2009

(54) Plug Unit for a Cable Entry

(76) Inventor: Stefan Milton, Ramdala (SE)

Correspondence Address: HARNESS, DICKEY & PIERCE, P.L.C., P.O.BOX 8910, RESTON, VA, 20195, US

(21) Appl. No.: 12/227,593

(22) PCT Filed: May 30, 2007
(86) PCT No.: PCT/SE2007/050387

§ 371 Date: Nov. 21, 2008

(30) Foreign Application Priority Data
May 31, 2006 (SE) 0601206 6

(51) Int. Cl. H01R 13/62; H01R 13/56

(52) U.S. Cl. 439/373; 439/447

(57) ABSTRACT

The present invention concerns a plug unit (1) for plugging an opening in a wall (22) the same time as it passes a cable, wire or pipe (20) through the same opening. The plug unit (1) comprises an exterior part (2) including a top portion (12) and a shaft portion 5 (11), an interior part (4) comprises a number of sheets (5), a penetrating channel (3) for receiving the cable, at least one ridge (13) attached to the shaft portion and extending outwardly from the shaft portion and wherein the device is composed of at least two identical parts (1′, 1″) to enable the plug unit (1) to be fitted laterally onto the cable, wire or pipe (20).

### FIELD OF INVENTION

This invention pertains in general to the field of cable entrance. More particularly the invention relates to a plug used for cable entries in walls or the like.

### BACKGROUND OF THE INVENTION

Today it exists a large number of different plug devices to hold and seal cables received in an opening in different places, such as a wall, electrical panel, cabinet, junction box etc. Normally, the known devices are designed for only one dimension of the cable to be received. Thus, a number of such devices must be kept in stock if cables of different diameters are to be used.

A plug or sealing device for cables should protect against dust, moisture etc., at the same time as it should hold the cable in a secure way.

### SUMMARY OF THE INVENTION

Accordingly, the present invention preferably seeks to mitigate, alleviate or eliminate one or more of the above-mentioned deficiencies in the art and disadvantages singly or in any combination and solves at least the above-mentioned problems by providing a device adaptable to cables of different diameters.

According to one aspect of the invention, there is provided a plug unit for plugging an opening in a wall at the same time as it passes a cable, wire or pipe through the same opening. The plug unit comprises an exterior part including a top portion and a shaft portion, an interior part comprises a number of sheets, a penetrating channel for receiving the cable, at least one ridge attached to the shaft portion and extending outwardly from the shaft portion and wherein the device is composed of at least two identical parts to enable the plug unit to be fitted laterally onto the cable, wire or pipe. Each one of the parts comprise a number of protrusions and grooves, which are located to fit together and prevent the identical parts from moving mutually when the plug unit is put together. The exterior part may have a circular, elliptical, square or multisided shape. The interior part together with the channel may be shaped according to any shape of the cable, wire or pipe or it may be circularly, square or elliptically shaped. The exterior part may be comprised of an elastomeric material or of a flexible material wherein the exterior part may be moulded. The sheets adhere strong enough to each other to stick together and loose enough to be peeled of by hand one by one. The ridges of the shaft portion are adapted to an opening for receiving the device and for establishing an axial sealing pressure at assembly of the plug unit.

The present invention has the advantage over the prior art that it provides a simple and, thus, inexpensive plug unit that gives a reliable and tight seal. Thus, it is simple both to produce and use and is at the same time reliable. A further advantage is that the plug unit may be held in place in the opening without the use of any adhesive, weld or other fastening means and independently of the thickness of the wall, plate etc. receiving the plug unit.

The plug unit according to the present invention should be able to be used irrespectively if the wall etc. receiving the plug unit is thinner than the axial dimension of the plug unit or not. By placing the ridges close together the plug units can safely be received in openings of thin walls. This feature means that plug units of only one axial dimension are needed for a certain diameter of an opening receiving the plug units.

Even though the invention has been developed for a cable entry and in particular to a cable entry through an opening in a wall by use of a plug unit, a person skilled in the art realises that the same technique may be used in many circumstances, e.g. for wires or pipes in any type of transition through a wall, electrical panel, cabinet, junction box or the like. For ease of description normally only the expressions “cable”, “opening” and “wall” are used in this description. As used in this description the expression “axial” and similar expressions are in relation to the opening in the wall etc. and, thus, also in relation to a cable or the like received in the plug unit.

### BRIEF DESCRIPTION OF THE DRAWINGS

Further objects, features and advantages of the invention will become apparent from the following description of several embodiments of the invention with reference to the drawings, in which:

FIGS. 1a, 1b and 1c are respectively a front view, side view and an end view of a plug unit according to the invention.

FIGS. 2a, 2b and 2c are respectively a front view, an interior side view and an end view of one half of the plug unit according to FIG. 1a-c.

FIG. 3 is a front view of another embodiment of a plug unit according to the invention.

FIG. 4 is a front view of a further embodiment of a plug unit according to the invention.

FIG. 5 is a front view of another embodiment of a plug unit according to the invention.

FIG. 6 illustrates a cable entry with a plug unit according to FIG. 1a-c with a minimum diameter of the channel of the plug unit and a maximum diameter of the channel of the plug unit.

### DESCRIPTION OF EMBODIMENTS

The following description focuses on an embodiment of the present invention applicable to a device for plugging an opening in a wall at the same time as it passes a cable through the same opening.

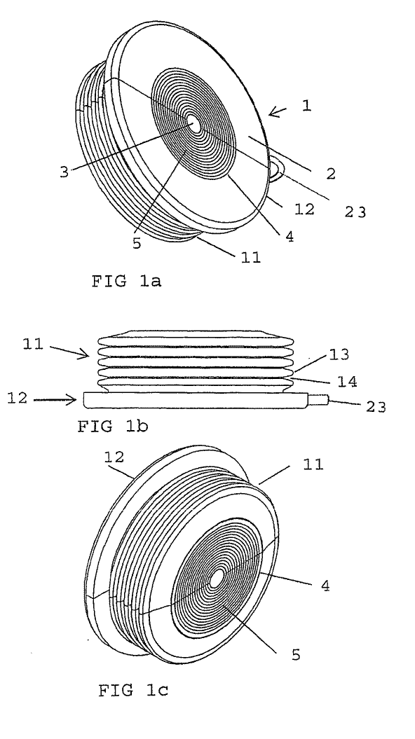

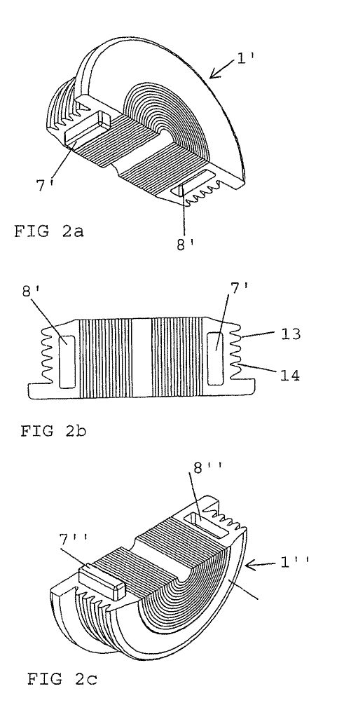

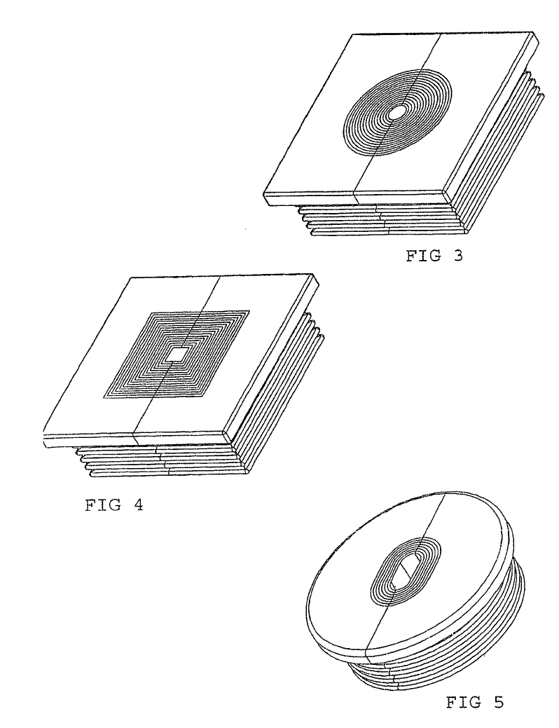

FIG. 1a-2c illustrates an embodiment of a plug unit 1 composed of an exterior circular part 2 and an interior circular part 4 with a circular penetrating channel 3 in centre. The plug unit 1 is further composed of two identical halves 1′, 1″, which are semicircular in cross section.

The exterior part 2 is normally moulded in a flexible or elastic material, preferably rubber, such as EPDM, or plastic. A person skilled in the art realises that any flexible material giving a tight seal and an appropriate holding effect on the cable may be used.

The interior part of the plug unit is composed of peelable sheets 5. The peelable sheets 5 are adhered to each other strong enough to hold the sheets 5 together but weak or loose enough for the sheets 5 to be peeled off by hand. By peeling off a suitable number of sheets the diameter of the channel 3 in the centre is adapted to the outer diameter of a cable, wire or pipe to be received in the plug unit 1. The number of sheets 5 peeled off should be such that the diameter of the channel formed in centre of the plug unit 1 should be slightly smaller than the outer diameter of the actual cable received inside said channel of the plug unit 1. Thereby, the elastic plug unit 1 will be pressed against the cable when the two halves 1′, 1″ of the plug unit 1 is assembled and the plug unit is pushed into an opening. If no cable is to be received in the plug unit a blind in form of a round, square etc. centre core may be placed in the channel (not shown).

The plug unit 1 comprises a top portion 12 and a shaft portion 11. The diameter of the top portion is larger than the diameter of the shaft portion. Thus, the top portion 12 forms a flange protruding outside the shaft portion 11.

The diameter of the top portion 12 may be of any shape so that it will cover the entire front side of the opening to be plugged. This is because the top portion is intended to cover the front side of the opening, which in most cases is exposed to elements, or outside areas, where material, such as dust, moisture or water, is to be kept from entering the opening. Thus, in order to prevent such material from entering the opening the top portion should be large enough to cover the front side of the opening. Although a circular top portion 12 is shown in FIG. 1a-2c it is not intended that the scope of the invention be limited to a circular-shaped top portion or that the openings be limited to circular openings. The top portion of the plug device should be thick enough to have sufficient strength to withstand conditions in which the plug is intended to operate. In any event the top portion should be thick enough to attach to and support the shaft portion and withstand the force necessary to push the plug unit into the opening.

On the outside of the shaft portion grooves 14 and ridges 13 are formed. In the shown embodiment there are five grooves 14. By placing the ridges 13 and the grooves 14 relatively close together the plug unit 1 could be safely received in openings of both thin plates and thick walls. The only limiting factor is that the distance between the top portion 12 and the adjacent first ridge 13 should be larger than the thickness of the wall or plate. Thus, the plug unit 1 functions irrespectively of if the wall, plate etc. is thicker or thinner than the axial dimension of the plug unit. In a preferred embodiment the distance between two ridges 13 is about 2 mm. The distance between the top portion 12 (flange) and the adjacent ridge 13 is about 1 mm, which distance is measured from the surface of the top portion 12 facing the ridges 13 and the top of the first ridge. By having a small distance between the ridges and an even smaller distance between the “first” ridge and the top portion 12 the plug unit 1 is safely held in walls being much thinner than the axial extent of the plug unit 1. By having a distance of 1 mm or less between the top portion 12 and the adjacent ridge 13 and a distance of 2 mm or less between the ridges 13, the plug unit of the present invention could be used in any normally used thin plate.

FIGS. 2a and 2c shows the plug unit separated into two halves 1′, 1″ where each halves comprises a protrusion 7′, 7″ and a groove 8′, 8″ which are suited to fit together and prevent the halves to move mutually when the plug unit is closed and pushed into the opening. The semicircular halves 1′, 1″ are arranged so that when the halves are brought together, a plug unit is formed with a top portion 12 which has a diameter larger than the diameter of the opening in the wall and a shaft portion 11 with a diameter slightly larger than the diameter of the opening in the wall.

In use the appropriate number of sheets 5 for the actual cables are peeled off from the interior part of each half 1′, 1″ of the plug unit. Then a cable, which has been passed through the opening in the wall, is placed in the channel part of one of the halves 1′, 1″. Finally, the halves 1′, 1″ are brought together, and then the plug unit is pushed into the opening in the wall and the plug unit is pressed against the cable received.

The plug unit is kept in place by use of a sealing pressure, as the parts of the plug unit are drawn together, which is accomplished between the plug unit and walls of the opening, i.e. without the use of any adhesive or other means of attachment. The dimensions of the grooves 14 and ridges 13 of the plug are such that a radial as well as axial sealing pressure is given. The radial/axial sealing pressure is given in that the outer diameter of the shaft portion of the plug is slightly larger than the inner diameter of the opening in the wall.

The cable may consist of tubings, pipes, an electric cable or any elongated object in general.

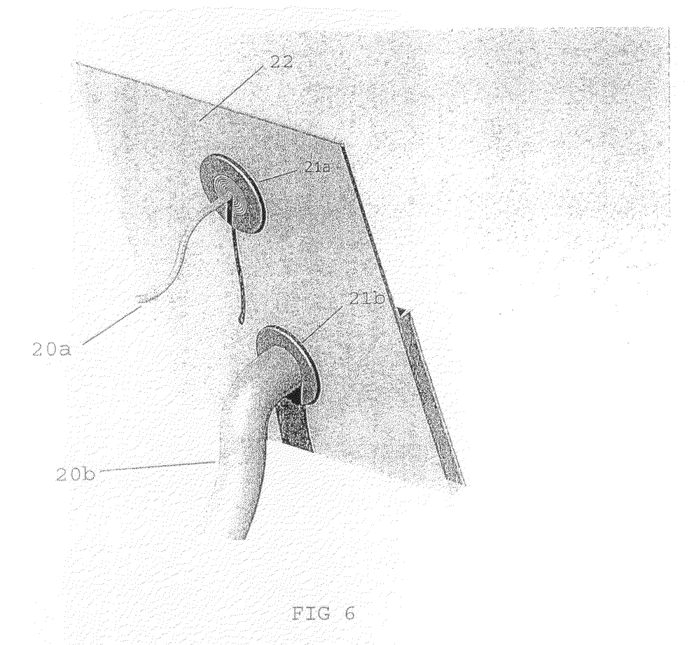

The present invention is not limited to a circular shaped plug unit but it may also include, for example, a plug unit having a square, triangular, or any other shaped cross-section. The exterior part and the interior part of the plug unit may also be of different shape, such as a square shaped exterior part and a circular interior part which is shown in FIG. 3, depending on the shape of the opening and the shape of the received cable. Other examples of combinations are shown in FIGS. 4 and 5.

FIG. 6 shows how the plug unit is adapted to a cable 20a with a small diameter and arranged into an opening 21a in a wall 22. FIG. 6 also shows how the plug unit is adapted to a cable 20b with a large diameter and arranged into an opening 21b in a wall 22.

Although the present invention has been described above with reference to a specific embodiment, it is not intended to be limited to the specific form set forth herein. Rather, the invention is limited only by the accompanying claims and, other embodiments than the specific above are equally possible within the scope of these appended claims.

The two halves forming a plug stick together by means of a band or bridge 23. One end of the bridge 23 is fixed to the side of the top portion 12 of one plug half 1′, while the other end of the bridge 23 is fixed to the side of the top portion 12 of the other plug half 1″. The bridge 23 is normally formed together with the plug halves 1′, 1″, and, thus are normally made of the same material and integrally with the plug halves 1′, 1″. By means of the bridge 23 the two plug halves 1′, 1″ stick together, facilitating handling.

1. A plug unit for plugging an opening in a plate or wall at the same time as it passes a cable, wire or pipe through the same opening, wherein the plug unit comprises an exterior part including a top portion and a shaft portion;
an interior part comprising a number of sheets adhering strong enough to each other to stick together and loose enough to be peeled of by hand;
a penetrating channel for receiving the cable; and
a number of closely placed ridges attached to the shaft portion and extending outwardly from the shaft portion;
that the plug unit is composed of at least two identical halves to enable the plug unit to be fitted laterally onto the cable, wire or pipe;
that the axial distance between the top portion and the first, adjacent ridge is smaller than the axial distance between two ridges adjacent to each other; and
that the axial distance between two adjacent ridges is about 2 mm.

2. The plug unit according to claim 1, wherein the axial distance between the top portion and the first ridge is half of the distance between two adjacent ridges.

3. The plug unit according to claim 1, wherein the axial length of the plug unit is larger than the thickness of the plate or wall receiving the plug unit.

4. The plug unit according to claim 1, wherein each one of the parts comprises a protrusion and a groove, which are located to fit together and prevent the identical parts from moving mutually when the device is put together.

5. The plug unit according to claim 1, wherein the exterior part has a circular, elliptical, square or multisided shape, the interior part together with the channel is shaped according to any shape of the cable, wire or pipe and the interior part together with the channel is circularly, square or elliptically shaped.

6. The plug unit according to claim 1, wherein the exterior part is comprised of an elastomeric material.

7. The plug unit according to claim 1, wherein a bridge is fixed with one end each to the side of the top portion of respective half.

8. The plug unit according to claim 7, wherein the bridge is made integral with the halves.

9. The plug unit according to claim 1, wherein the outer diameter of the ridges are larger than the inner diameter of the opening for receiving the plug unit, whereby an axial sealing pressure is established at assembly of the plug unit.
